(19) United States
(12) Patent Application Publication
(10) Pub. No.: US 2015/0107371 A1
(43) Pub. Date: Apr. 23, 2015

(54) METHOD AND SYSTEM FOR DETERMINING CHARACTERISTICS OF AN ACOUSTIC SIGNAL

(71) Applicant: General Electric Company, Schenectady, NY (US)

(72) Inventor: Oleg Alexander Khrakovsky, Lynn, MA (US)

(73) Assignee: General Electric Company, Schenectady, NY (US)

(21) Appl. No.: 14/057,517

(22) Filed: Oct. 18, 2013

(51) Int. Cl. G01F 1/66

(52) U.S. Cl. CPC G01F 1/66
USPC 73/861.28

(57) ABSTRACT

A method and system for measuring characteristics of an acoustic signal traveling through a fluid in a pipe uses an ultrasonic transducer attached directly to the pipe. The transducer is disposed in a housing attached to an outside surface of a flange of the pipe. The transducer fires an acoustic signal and its characteristics are measured.

### BACKGROUND OF THE INVENTION

The subject matter disclosed herein relates to pipe mounted transducers for measuring characteristics of an acoustic signal through a fluid in the pipe, using one or more transducers attached to the pipe flange.

Sensors can be used in determining characteristics inside pipes and piping systems, such as pressure, flow volume, flow rate, temperature, moisture and humidity, and fluid density, among others. The sensors can be integral in providing measurement and control of fluids in the pipes, and in monitoring operations and operating conditions in or near the pipes.

One type of sensor that may be used for the piping systems outlined herein includes ultrasonic transducers that emit and detect acoustic signals. These ultrasonic transducers may incorporate a piezoelectric material, such as a piezoelectric crystal, and are mounted in a housing that may be attached to a pipe. During operation, predetermined electrical pulses are generated and transmitted to the ultrasonic transducers by programmed electronics connected to the ultrasonic transducers. The electrical pulses are applied to electrodes that are connected to the piezoelectric material which, in turn, cause a physical deflection in the piezoelectric material which generates ultrasonic energy (e.g., ultrasonic signals or beams) that is transmitted into the fluid in the pipe to which the ultrasonic transducer is coupled.

When conducting ultrasonic measurements, the ultrasonic acoustic signals or beams are emitted from one or more ultrasonic transducers mounted on the pipe and pass into the pipe wall and the fluid in the pipe. As the ultrasonic acoustic signals pass through the pipe and the fluid therein, various ultrasonic reflections called echoes occur as the ultrasonic beams interact with the pipe walls. These echoes may be detected by the emitting ultrasonic transducer or by one or more other ultrasonic transducers connected to the pipe. In addition, a non-reflected ultrasonic wave may be directly detected by one or more of the transducers if the emitting ultrasonic transducer is aimed toward the detecting, or receiving, ultrasonic transducer.

When an emitted ultrasonic signal, or its echo, contacts the surface of the piezoelectric material of an ultrasonic transducer it generates a detectable voltage difference across the transducer's electrodes which may then be transmitted as an electric signal to connected processing electronics for recordation as detected ultrasonic data. These data may include an amplitude and a return delay time, also known as a transit time or a time-of-flight. By tracking the time difference between the transmission of the electrical pulses and the receipt of the detected ultrasonic data (electric signals), and measuring its amplitude, various characteristics of the piping system may be determined.

Oftentimes, because of equipment used to connect the sensors to the pipes, a relatively large amount of space is occupied to connect the small sensors to the pipes. Space to fit sensors attached by large wedges, buffers, or standoffs can become very crowded and thereby limit the number of sensors that can be used in a given area, and limit control and operation of the pipe system. Adding sensors or relocating sensors after the initial design of a pipe system can be very difficult and expensive.

The discussion above is merely provided for general background information and is not intended to be used as an aid in determining the scope of the claimed subject matter.

### BRIEF DESCRIPTION OF THE INVENTION

A method and system for measuring characteristics of acoustic signals traveling through a fluid in a pipe uses an ultrasonic transducer attached directly to the pipe. The transducer is disposed in a housing attached to an outside surface of a flange of the pipe. The transducer fires an acoustic signal and its characteristics are measured. The method employs ultrasonic transducers secured to opposite surfaces of a pipe flange that are parallel to the axis of the pipe. The longitudinal mode signals are acquired using either through-transmission or pulse-echo modes. An accurate speed and attenuation of the acoustic signals can be determined from the difference of arrival times of multiple echoes, their amplitudes, and the internal diameter of the pipe. An advantage that may be realized in the practice of some disclosed embodiments of the flange clamp is an accurate and non-invasive measurement of the characteristics of acoustic signals that can be used to determine various properties of a fluid in a pipe using an existing flange without piping modifications. This method can also be used to measure change in the physical dimensions of the pipe and/or flange due to variations in pressure and/or temperature.

In one embodiment, a system is disclosed that measures a characteristic of an acoustic signal traveling through a fluid in a pipe. The system includes a first transducer disposed in a housing that is secured in direct physical contact against an outside surface of a flange of the pipe. The transducer is configured to receive an electrical pulse and, in response to the pulse, to generate an acoustic signal traveling through the fluid and intersecting a central axis of the flange.

In another embodiment, a method of determining a characteristic of an acoustic signal traveling through a fluid in a pipe is disclosed. The method includes attaching a housing of a transducer directly on an outside surface of a flange of the pipe. An acoustic signal is fired from the transducer into the flange, and its time-of-flight is measured.

In another embodiment, an apparatus for securing at least one transducer against a flange of a pipe is disclosed. The apparatus includes a clamp having a first section and a second section. A threaded rod is attached to the first and second sections for drawing the first and second sections together. The first section has a slot for receiving a transducer therein, and the first and second sections are spaced apart to allow the flange to fit therebetween.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a diagram of an end view of an exemplary acoustic signal measurement system;

FIG. 2 is a diagram of a side view of the exemplary acoustic signal measurement system of FIG. 1; and

FIG. 3 is a cross-sectional view of an exemplary ultrasonic transducer used in the acoustic signal measurement system of FIG. 1.

### DETAILED DESCRIPTION OF THE INVENTION

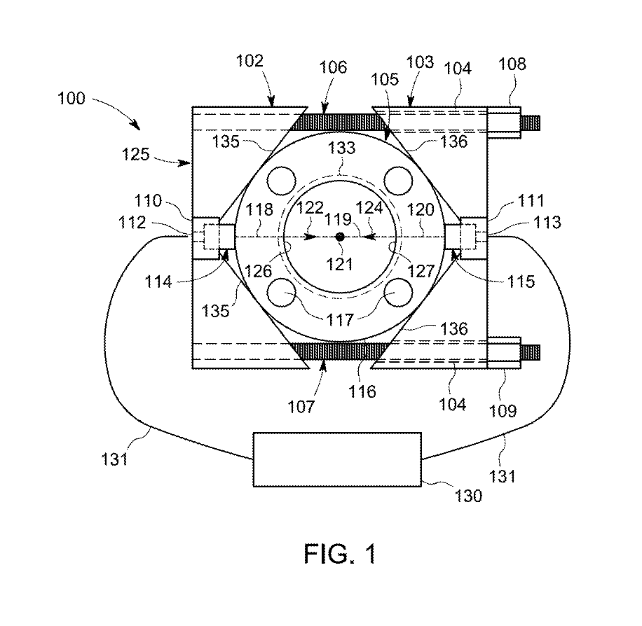

With reference to FIG. 1, there is illustrated an acoustic signal measurement system 100 comprising a circular pipe flange 105, at one end of a pipe 133, having a clamp 125 attached thereto. The pipe 133, flange 105, and clamp 125 may each be made from a metal, such as aluminum, steel, or stainless steel, or they may each be made from a suitable plastic. As shown in FIG. 1, the pipe 133 (outside diameter indicated by the dashed line), with which the flange 105 is integrally formed, extends into the page. The clamp 125 includes first and second sections 102, 103, attached to each other using nuts 108, 109 and corresponding threaded rods 106, 107, respectively, disposed in a plurality of through-holes 104. The clamp 125 may be tightened against the outside surface 116 of the flange 105 by rotating the nuts 108, 109 which draws or forces the first and second clamp sections 102, 103 together. The clamp sections 102, 103 include angled interior surfaces 135, 136, respectively, for providing at least two contact pressure areas with each clamp section 102, 103 against the flange 105, and for providing a space to allow the flange 105 to fit therebetween. Although the angled interior surfaces 135, 136 are illustrated as planar shaped surfaces, the angled interior surfaces may be curved to any extent desired. These interior surfaces of the clamp 125 may comprise a curvature matching that of the exterior surface 116 of the flange 105 to provide an increased contact area as between the clamp 125 and the flange 105.

Each clamp section 102, 103 comprises a slot 110, 111, respectively, located near a center portion of each of the clamp sections 102, 103 for receiving and securing therein an ultrasonic transducer 114, 115, respectively, which may include, for example, ultrasonic transducers. FIG. 3 illustrates an exemplary ultrasonic transducer that may be used in one embodiment of the acoustic signal measurement system 100. As the nuts 108, 109 are tightened by rotation, the clamp 125 presses the ultrasonic transducers 114, 115 with increasing force against the outside surface 116 of the flange 105, as shown. Although each of the exemplary clamp sections 102, 103, are illustrated as having a slot 110, 111 for receiving an ultrasonic transducer 114, 115, a second exemplary embodiment of the clamp 125 may include a slot for receiving a transducer in only one of the clamp sections 102, 103. Alternately, only one transducer may be disposed in one of the two slots 110, 111 for performing an acoustic signal measurement as described hereinbelow.

The ultrasonic transducers 114, 115 each comprise a connector portion 112, 113, respectively, which extends through an opening in the clamp sections 102, 103, for electrically connecting the ultrasonic transducers 114, 115 to electronic circuits of the processing system 130 via electrical communication cables 131. The processing system 130 may be programmed to transmit control signals (electrical pulses) to one or more connected ultrasonic transducers 114, 115 and to receive responsive electrical signals therefrom. The programmed electrical pulses transmitted from the processing system 130 and received at the one or more ultrasonic transducers 114, 115 cause the transducer to emit an acoustic signal, or beam, into the flange 105 via its piezoelectric element 303 (FIG. 3), which may be a piezoelectric crystal, as explained above. These emitted acoustic signals may be detected by a receiving ultrasonic transducer 114, 115 also via its piezoelectric element 303, as explained above. In a two-transducer embodiment, as depicted in FIG. 1, one of the ultrasonic transducers, e.g. ultrasonic transducer 114, may emit an acoustic signal that is detected by the other ultrasonic transducer 115. The receiving ultrasonic transducer 115 may detect the emitted acoustic signal directly and it may detect reflections, or echoes, of the emitted acoustic signal. In a single-transducer embodiment, the one ultrasonic transducer emits an acoustic signal and detects reflections, or echoes, of the emitted acoustic signal.

The detected acoustic signals cause the receiving ultrasonic transducer 115 to transmit corresponding electric signals to the processing system 130 which then determines a time-of-flight of the acoustic signal as measured between the time of emission of the acoustic signal and its detection. Such times-of-flight may be recorded in a memory of the processing system 130 and used for various computations depending on the dimensions of the flange 105, its interior diameter, and on the particular application for which the acoustic signal measurement system 100 is used, among others. Such other computations may involve computing characteristics related to a density of the fluid or temperature of the fluid based upon measured times-of-flight.

In the two-transducer exemplary embodiment illustrated in FIG. 1, the first ultrasonic transducer 114 may fire an acoustic signal into the flange 105 that travels along a path in a first portion 118 of the flange 105, then along a path through a fluid in the interior diameter 119 of the flange 105 that intersects a central axis 121 of the flange 105 and pipe 133, and along a path in a second portion 120 of the flange 105, to a second ultrasonic transducer 115 which detects the acoustic signal and converts it into an electronic data signal for transmission to processing system 130 over cable 131. The processing system 130 may precisely measure and record the time-of-flight as the time duration between emitting the acoustic signal from the first ultrasonic transducer 114 and directly detecting it at the second ultrasonic transducer 115. In operation, this detected acoustic signal at the second transducer 115 includes a portion of the energy of the acoustic signal. A remaining portion of the emitted acoustic signal, indicated by arrow 124, may reflect off of the interior wall 127 of the flange 105 and travel back to the emitting transducer 114. The processing system 130 may be selectively programmed to detect this reflected acoustic signal (echo) and calculate its time-of-flight. Moreover, another portion of the reflected acoustic signal indicated by arrow 124 may again reflect off of the interior wall 126 of the flange 105, indicated by arrow 122, and travel to the receiving transducer 115. Thus, the receiving transducer 115 may directly detect a first portion of the acoustic signal emitted by ultrasonic transducer 114 and subsequently detect an echo 122 of this acoustic signal. In this manner, both ultrasonic transducers 114, 115 may compute and record transit times for either direct and reflected acoustic signals. Similarly, in a single-transducer embodiment, the processing system 130 may precisely measure and record the time-of-flight as the duration between emitting the acoustic signal from the first ultrasonic transducer 114 and detecting its echo, or reflection, indicated by arrow 124, at the first ultrasonic transducer 114.

Each reflection, or echo, of the acoustic signal diminishes the acoustic energy carried by the acoustic signal until it becomes too weak to be detected. The rate of attenuation of such reflections may also be calculated by the processing system based on an amplitude of the received reflections, which decrease over time with each reflection. The rate of attenuation of the acoustic signal may also be used to determine characteristics of the fluid in the pipe, such as characteristics related to a density of the fluid.

To illustrate an exemplary calculation performed by the processing system 130, the recorded time-of-flight of the portion of an acoustic signal emitted by ultrasonic transducer 114 and directly detected first by ultrasonic transducer 115 may be designated as time-of-flight T₁. This acoustic signal emitted by ultrasonic transducer 114 may generate an echo detected by the second transducer 115, denoted by the arrow 122, which is a reflection from the interior flange wall 127, then 126, as described above. This echo detected by the second ultrasonic transducer 115 may have associated therewith a second time-of-flight T₂. If a fluid, whether stationary or flowing, is present within the pipe then, with reference to these times-of-flight T₁, T₂ just described, a computation may be performed for determining a speed of the acoustic signal through the fluid within the interior diameter of the flange 105. The time-of-flight in one direction through the interior diameter of the flange 105 (T_{fluid}), i.e., through the fluid, is computed by [(T₂-T₁)÷2], which may then be used to determine the acoustic signal speed (speed of sound) through the fluid by: (F_{ID})÷(T_{fluid}) where F_{ID} is the known interior diameter of the flange 105. It should be noted that someone skilled in the art may use various combinations of measured times-of-flight to perform calculations for determining various physical characteristics of a piping system using the acoustic signal measurement system 100 just described.

As is illustrated in FIG. 1, one or more transducers 114, 115 disposed on either or both clamp sections 102, 103, are aimed in a direction directly toward the central axis 121 of the flange 105 and pipe 133 attached thereto. In a two-transducer embodiment, the ultrasonic transducers 114, 115 are disposed within clamp slots 110, 111 and are pressed against the outside surface of the flange 105 directly opposite each other to acoustically couple the ultrasonic transducers 114, 115 to the flange 105 so that the acoustic signal intersects a central axis 121 of the flange 105 and pipe 133. In such an embodiment, either or both of the ultrasonic transducers 114, 115 may be utilized by the processing system as an acoustic signal emitting transducer and an acoustic signal detecting transducer. Moreover, the one or more transducers disposed on either or both clamp sections 102, 103, are preferably positioned so that the acoustic signals do not traverse the bolt holes 117 that are used to couple flange pairs when connecting section of pipe having a flange 105 attached thereto.

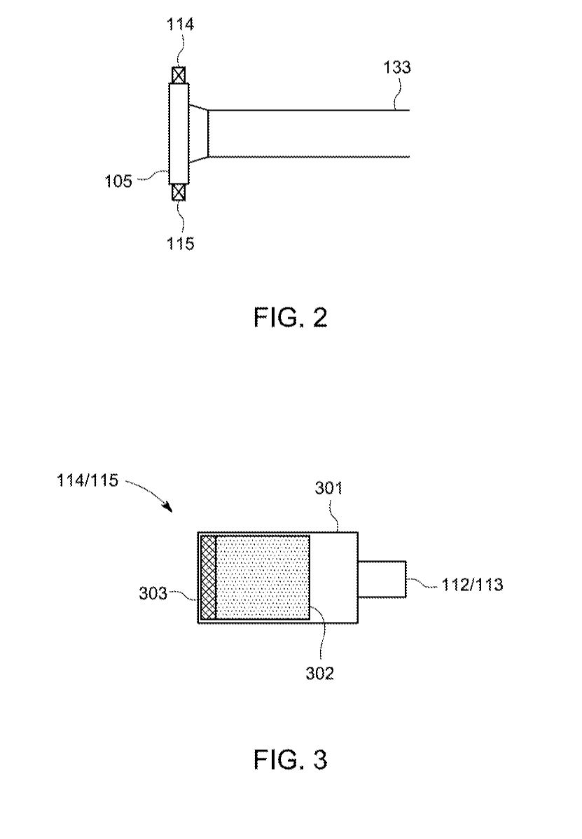

FIG. 2 illustrates a side view of the exemplary acoustic signal measurement system 100 without the clamp attached thereto for ease of illustration. The positioning of the ultrasonic transducers 114, 115 directly on the flange 105 of the pipe 133 eliminates the need for an acoustic wedge disposed between the ultrasonic transducer 114, 115 and the pipe 133 itself for transmitting acoustic signals, e.g., as shear acoustic signals, or waves, from the ultrasonic transducers 114, 115 into the fluid in the pipe. This allows direct coupling of the ultrasonic transducers 114, 115 to the flange 105 and use of longitudinal signals, or waves.

FIG. 3 illustrates an exemplary embodiment of an ultrasonic transducer 114, 115 comprising a piezoelectric element 303, such as a piezoelectric crystal, disposed within a transducer housing 301 directly against an interior surface of the transducer housing 301. This allows the piezoelectric element 303 to be directly acoustically coupled to the flange 105 without requiring wedges, standoffs, or other acoustic buffers to be used, when the transducer housing 301 is clamped directly against the flange 105. A transducer backing 302 is positioned in the housing adjacent to the piezoelectric element 303 to secure it against the interior surface of the transducer housing 301 and to provide a rigid or semi-rigid support material for the piezoelectric element 303.

In view of the foregoing, embodiments of the invention efficiently couple the acoustic transducers 114, 115 to a flange 105 and any fluid inside the pipe 133 for precisely measuring a time-of-flight of acoustic signals generated thereby. This provides easier removal of the transducers 114, 115 without extra hardware costs. The flange 105 also serves as a thermal buffer to protect the transducers 114, 115 against temperature extremes of any fluids in the pipe.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for measuring a characteristic of an acoustic signal through a fluid in a pipe, the system comprising:
a first transducer disposed in a first transducer housing, the first transducer housing secured in direct physical contact against an outside surface of a flange of the pipe; and
wherein the first transducer is configured to receive an electrical pulse and to generate an acoustic signal in response to the electrical pulse, the acoustic signal traveling through the fluid and intersecting a central axis of the flange.

2. The system of claim 1, further comprising:
a second transducer disposed in a second transducer housing, the second transducer housing secured in direct physical contact against the outside surface of the flange directly opposite the first transducer; and
the second transducer configured to detect the acoustic signal generated by the first transducer and to generate an electrical signal corresponding to the detected acoustic signal.

3. The system of claim 2, further comprising a processing system connected to the first transducer and to the second transducer, the processing system configured to transmit the electrical pulse to the first transducer and to receive the electrical signal from the second transducer.

4. The system of claim 3, wherein the processing system is programmed to calculate a speed of the acoustic signal through the fluid in the pipe based on a time of flight of the acoustic signal.

5. The system of claim 2, further comprising a clamp for securing the first and second transducer housings against the outside surface of the flange.

6. The system of claim 1, wherein a piezoelectric element of the first transducer is adjacent to the transducer housing.

7. A method of determining a characteristic of an acoustic signal traveling through a fluid in a pipe, the method comprising:
attaching a housing of a first transducer directly on an outside surface of a flange of the pipe;
firing an acoustic signal from the first transducer into the flange; and
measuring a time of flight of the acoustic signal.

8. The method of claim 7, wherein a piezoelectric element of the first transducer is adjacent to the transducer housing.

9. The method of claim 7, further comprising attaching a second transducer on the outside surface of the flange directly opposite the first transducer such that a first portion of the acoustic signal travels from the first transducer to the second transducer intersecting a central axis of the flange.

10. The method of claim 9, further comprising reflecting a second portion of the acoustic signal from an interior surface of the flange of the pipe such that the reflected second portion of the acoustic signal travels to the second transducer after the first portion of the acoustic signal.

11. The method of claim 10, further comprising disposing a fluid in an interior of the pipe such that the acoustic signal travels through the fluid.

12. The method of claim 11, further comprising calculating a speed of the acoustic signal through the fluid in the pipe.

13. The method of claim 11, further comprising calculating a time of flight of both the first portion and the second portion of the acoustic signal for calculating a speed of the acoustic signal through the fluid in the pipe.

14. The method of claim 7, wherein the step of measuring the time of flight of the acoustic signal comprises the first transducer detecting an echo of the acoustic signal.

15. The method of claim 9, wherein the step of measuring the time of flight of the acoustic signal comprises the second transducer detecting the first portion of the acoustic signal traveling from the first transducer to the second transducer.

16. The method of claim 10, further comprising the second transducer detecting the second portion of the acoustic signal traveling from the first transducer to the second transducer.

17. An apparatus for securing at least one transducer against a flange of a pipe, the apparatus comprising:
a clamp having a first section and a second section;
a threaded rod attached to the first and second sections for drawing the first and second sections together;
the first section having a first slot for receiving a first transducer therein; and
the first and second sections spaced apart to allow the flange to fit therebetween.

18. The apparatus of claim 17, wherein the threaded rod comprises a threaded nut for pulling the first and second sections together when the nut is rotated around the threaded rod for tightening the first transducer against an outside surface of the flange.

19. The apparatus of claim 17, wherein the second section comprises a second slot for receiving a second transducer therein.

20. The apparatus of claim 19, wherein the first and second slots are disposed in each of the first and second sections such that the first and second transducers face each other toward a central axis of the flange when the first and second transducers are tightened against the outside surface of the flange.
